(19) United States
(12) Patent Application Publication
(10) Pub. No.: US 2008/0162300 A1
(43) Pub. Date: Jul. 3, 2008

(54) System and Method for Purchasing Linked with Broadcast Media

(76) Inventor: Stephen A. Ewald, Tampa, FL (US)

Correspondence Address: WOODCOCK WASHBURN LLP, CIRA CENTRE, 12TH FLOOR, 2929 ARCH STREET, PHILADELPHIA, PA, 19104-2891, US

(21) Appl. No.: 12/049,877

(22) Filed: Mar. 17, 2008

Related U.S. Application Data
(63) Continuation-in-part of application No. 10/672,133, filed on Sep. 26, 2003.

(51) Int. Cl. G06Q 30/00

(52) U.S. Cl. 705/26

(57) ABSTRACT

A system and method for purchasing goods and services related to a media stream, such as a radio or television broadcast, where a broadcast receiver receives a media stream. A person purchases the goods and services by indicating on a device the desire to purchase. The device can capture a portion of the media stream from the broadcast receiver The device analyzes directly or requests analysis of the media stream from a remote device to determine the goods or services associated with the stream. The device selectively records the purchase data for the goods and services, and relays the purchase data to one or more servers that selectively receive and verify the purchase data. The transmission of the purchase data from the device can occur at the time of purchase, or at some other predetermined period or location.

### CROSS-REFERENCE TO RELATED APPLICATION

The present application is a continuation in part application and claims priority to U.S. application Ser. No. 10/672,133, filed Sep. 26, 2003, entitled “System and Method for Purchasing Linked with Broadcast Media”, which is hereby incorporated by reference herein in its entirety.

### BACKGROUND OF THE INVENTION

1. Field of the Invention

The present invention generally relates to broadcast media and the sale of goods and services using the media. More particularly, the invention relates to a system and method to allow remote purchases of goods and services based upon advertising in broadcast media.

2. Description of the Related Art

Broadcast media, such as radio and television, has been advertising goods and services for audience purchase since the inception of the media. In typical advertising situations, the broadcast media will include a description of the good or service such that the listener or viewer can learn at least the identity or brand name of the good or service and potentially some of the benefits and desirability of purchase. In some instances, the specific physical location where one can purchase the good or service is also disclosed.

More recently, there has been advertisement conducted in broadcast media that is linked with another communication media, such as telephone or Internet access, whereby a person seeing a good or service advertised can affect purchase of the good or service through contacting a sales department through a separate communication media. For example, if a radio listener were to hear a certain service advertised with a telephone number given, he or she could call the telephone number either upon hearing it, or record the number and call at some point thereafter. With the advent and pervasiveness of cellular telephones, persons driving in cars or otherwise remotely listening to broadcast radio can likewise purchase goods or services in this manner. There have also been specific dedicated advertising broadcast channels of media, radio, television, and satellite, which only advertise goods and services for purchase. These channels typically have a dedicated phone number and/or Internet sites for audience purchase, and give a specific identifier to the goods and services being sold, such as a predetermined product code or number, so that the purchaser need only remember the product identifier when calling and not have to recall and give a significant description of the goods or services desired.

These systems of broadcast media advertisements however typically require that the persons in the audience separately contact the seller of the good or service, and remember both the method to contact the seller, i.e. phone number or Internet site, and the description of the goods or service desired purchased, or at least the product identifier code. Further, the person receiving the broadcast media and advertisement may be remotely located from a communication channel, and also may be unable to devote much attention to the purchase of the good or service, such as a person driving a car and listening to advertising on the radio. In such a situation, the difficulty of directly purchasing the good or service, recording the purchase and contact information, or simply remembering the purchase contact information or good or service description, all adversely impact the potential sale of the good or service.

Another problem encountered in advertising accompanying broadcast media is that there often exists other media transmitted in the broadcast media that may be available for purchase but no specific advertising or identifying material for media is in the broadcast to alert the potential purchaser of the purchasing ability. An example is a song being broadcast over the radio where the song's title or artist has not been separately announced such that a listener can identify the song for purchase. In such instance, the listener or potential purchaser must take extra action to both learn of the purchase information for the specific good or service contained in the broadcast media, and then learn where to actually purchase the good or service.

Accordingly, it would be advantageous to provide a system and method to allow a person hearing and/or seeing broadcast media to easily make a purchase for a good or service advertised within the broadcast media without having to resort to a secondary communication. Once the person has indicated a desire to purchase, the system and method should not require further interaction from the person to verify or follow through with the purchase. Further, the system and method should allow the purchase of goods and services identified within the broadcast media even if specific identification data for the purchase has not been explicitly given. It is thus to the provision of such a system and method of providing a remotely accessible diagnostic interface that the present invention is primarily directed.

### SUMMARY OF THE INVENTION

The present disclosure is directed to a system and method for purchasing goods and services related to broadcast media, such a radio or television broadcast, where a broadcast receiver receives a media which may include information that relates to goods and services that can be purchased by persons receiving the media. The receiver allows a person to purchase the goods and services by allowing a person to indicate a desire to purchase, such as by simply pressing a button on a radio receiver, and then selectively records the purchase data for the good and service and relays the purchase data to one or more servers that selectively receive and verify the purchase data. The purchase data may be determined from information within the broadcast, or it may be determined by analyzing a portion of the broadcast and determining purchase data based on the results of the analysis. The transmission of the purchase data from the receiver can occur at the time of purchase, via a communication with another device, or at some other predetermined period wherein all stored purchase data is sent to the device where the purchase is completed.

In one embodiment, the method for purchasing goods and services related to broadcast media particularly includes the steps of receiving at a broadcast receiver a broadcast media including information relating to goods and services that can be purchased by persons receiving the media, selectively recording purchase data at the broadcast receiver for a good and service that a person purchases relating to the broadcast media, sending the purchase data from the broadcast receiver to at least one server, receiving the purchase data at the at least one server, and verifying the purchase data from the broadcast receiver at the least one server. The method can include the step of storing the purchase data and then transmitting the stored purchase data to a server at a predetermined period, such as when the receiver is able to communicate with the server or another computer device.

In another embodiment, the method for purchasing goods and services related to broadcast media particularly includes the steps of receiving at a broadcast receiver a broadcast media which does not include specific information relating to goods and services that can be purchased by persons receiving the media, analyzing the broadcast media to determine purchase data, selectively recording purchase data at the broadcast receiver for a good and service that a person purchases relating to the broadcast media, sending the purchase data from the broadcast receiver to at least one server, receiving the purchase data at the at least one server, and verifying the purchase data from the broadcast receiver at the least one server. This method can also include the step of storing the purchase data and then transmitting the stored purchase data to a server at a predetermined period, such as when the receiver is able to communicate with the server or another computer device.

It is therefore an object of the system and method to provide a system and method to allow a person receiving a broadcast media at a remote receiver to make a purchase for a good and/or service advertised within the broadcast media. The person can indicated a desire to purchase the good or service, such as through simply pressing a button or actuating a switch, and no further interaction may be required with the person to make the purchase. Moreover, the broadcast receiver can allow the purchase of goods and services that are identified within the broadcast media, such as a song, even if specific advertising for the purchase has not occurred, by either utilizing identifying data within the stream of broadcast media or analyzing the broadcast media to determine identifying data.

Other objects, advantages, and features of the present invention will become apparent after review of the hereinafter set forth Brief Description of the Drawings, Detailed Description of the Invention, and the Claims.

### BRIEF DESCRIPTION OF THE DRAWINGS

FIG. 1 is a representative diagram of one embodiment of a system with the broadcast receiver for a broadcast media selectively communicating with a server, and potentially other computer devices, to purchase goods and services advertised within the broadcast media.

FIG. 2 is a perspective view and block diagram of one embodiment of the broadcast receiver.

FIG. 3 is a flowchart of the process executing on the broadcast receiver to purchase goods or services linked with the received broadcast media.

FIG. 4 is a flowchart of the process executing on the server that receives purchase data from the broadcast receivers.

FIG. 5 is a representative diagram of one embodiment of a system with a broadcast receiver illustrated as a television for receiving broadcast media data stream, and a device for detecting such data streams and selectively communicating with a server, and potentially other computer devices, to purchase goods and services detected within the broadcast media.

FIG. 6 is a flowchart of the process executing on a device capable of detecting a broadcast media stream and analyzing the stream for identification data.

### DETAILED DESCRIPTION

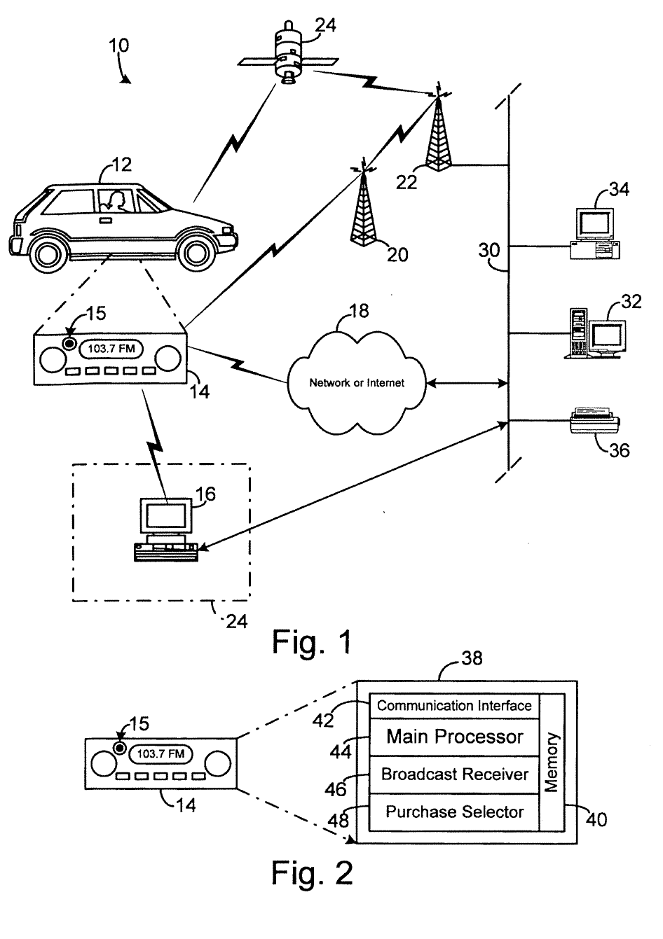

With reference to the figures in which like numerals represent like elements throughout, FIG. 1 illustrates one embodiment of a system 10 with the broadcast receiver 14 shown in an automobile 12 for a broadcast media, such as radio. The receiver 14 selectively communicates with a server 32, and potentially other computer devices, such as second computer 34 or other mobile communication devices such as PDAs, cellular telephones, and personal computers, to purchase goods and services advertised within the broadcast media. In the system 10, one or more broadcast receivers 14 receive broadcast media, such as a radio signal from broadcast tower 20. The media may include information relating to goods and services, such as songs or service advertisements, that can be purchased by persons receiving the media.

In this embodiment, the receiver 14 includes an indicator button 15 or other means so that the person can simply indicate the desire to purchase a good or service while that service is advertised in the broadcast media. As an example, if a listener hears a song played on the radio, he or she presses the button 15 to purchase the album that contains that song. The broadcast receiver 14 will inform the person if purchase is not available through an audible and/or visual alert after pressing the button 15. Once the button 15 is pressed, the broadcast receiver further records the purchase data and then transmits the purchase data to one or more servers, such as server 32 and 34, which selectively receive and verify purchase data sent from the one or more receivers 14.

System 10 is shown as having several potential avenues of communication between the broadcast receiver 14 at the automobile 12 and the one or more servers 32 and 34. At the time the purchase data is received, the broadcast receiver 14 can communicate directly to a server, such as server 32, through wireless network or internet connection 18, through a radio relay such as a communication with a satellite 24 which then relays the purchase data to a separate receiver 22 that communicates the data to a LAN 30 or other network where it is accessible to the server 32. The broadcast receiver 14 can also directly communicate with the receiver 22 of the LAN 30. Also shown on the LAN 30 side is a printer 36, which can include other immediate printing or outputting means once the purchase data is received server-side.

If embodied so as to store the purchase data, as is further described herein, the broadcast receiver 14 will store the purchase data and then transmit the stored data at a predetermined time or location. For example, the broadcast receiver 14 can store the purchase data and then when the automobile 12 is in range of the wireless network or line-of-sight communication of the home computer 16 at the home 24, a wireless communication can be made whereby the broadcast receiver 14 transmits the purchase data to the home computer 16 and the home computer 16 then transmits the purchase data to the server 32 or server-side LAN 30. Alternately, the broadcast receiver 14 can simply store the purchase data until it is in range of the server-side receiver 22, or can send the purchase data at a predetermined time so that the server-side devices are anticipating receipt of any purchase data, e.g. all purchase data is sent at 6 pm. Once the purchase data is verified, the delivery of the good or service can be accomplished through any method known in the art, such as mail, courier, direct download or electronic transaction, follow up communication, or other delivery method.

The components of the broadcast receiver 14 are more particularly shown in the block diagram of FIG. 2. The broadcast receiver 14 includes a computer platform 38 with a main processor 44, such as those manufactured by Intel®, Motorola®, or Texas Instruments®, performing all central logic, as is known in the art, and a memory 40 is present to store and forward data from any component as necessary. On the platform 38 is the broadcast receiver 46 for receiving the broadcast media, which can be radio, television, shortwave, or other digital or analog over-the-air signals. There is also a purchase selector 48 that communicates with communications interface 42 to transmit the purchase data to another computer device, such as server 32. The purchase selector 48, in this embodiment, interfaces with the selection button 15 to determine when a person desires to purchase a good or service in the broadcast media. Main processor 44 can determine whether or not identification data is present in the broadcast media data stream so that the good or service can be identified for purchase. Main processor 44 may then operate in conjunction with communications interface 42 to request the purchase of a good or service identified from the broadcast media data stream.

If identification data is not present in the broadcast media data stream, or if the components of broadcast receiver 14 are not designed to detect such identification data, main processor 44 can analyze the broadcast media data stream to determine the identification data.

Alternatively, main processor 44 may operate in conjunction with communications interface 42 to request analysis of the broadcast media data stream from a remote device, such as server 32 or second computer 34. Main processor 44 may then receive the results of such analysis through communications interface 42 and then request the purchase of a good or service identified by analysis of the broadcast media data stream. In another embodiment, main processor 44 may operate in conjunction with communications interface 42 to request purchase of a good or service associated with the broadcast media data stream from a remote device, such as server 32 or second computer 34, and forward or otherwise notify the remote device of the contents of the broadcast media data stream. However, any of the components shown can include logic sufficient to perform any step or function as described herein.

In one embodiment, the identification data may be in-band, within the broadcast media data stream, so that a separate communication channel to communicate identification data, or analysis of the broadcast media data stream to determine identification data, is unnecessary. An example is a data frame at the beginning of a song that the broadcast receiver 14 records so that if the song is selected for purchase during its broadcast, the receiver 14 will have the identification data readily available. Thus, upon the next song being played, the new frame is loaded, or if no frame is present, the receiver does not attempt purchase of the song even if requested. Alternately, the broadcast receiver 14 can include logic to gather data from other components, such as the specific broadcast receiver 46 as to the channel currently being monitored, and if the time is also recorded, the relay of the channel and time within the purchase data can be looked up at the server 32 to determine the identification of the good or service desired purchased.

In another embodiment, identification data may not be provided with the broadcast media data stream. This may be because a particular song, video, or other discrete portion of a broadcast media data stream is missing or has a blank or otherwise deficient identification data frame in a system designed to provide such identification data frames. Alternatively, the broadcast media data stream may be broadcast in a system that does not use data frames for identification data. In such systems, identification data of the broadcast media data stream may be obtained by analyzing the broadcast media data stream itself. For example, methods and systems are known to those skilled in the art which can determine from a sample of song the artist and title of the song. A common commercial service that allows mobile devices to recognize music is called “Shazam” and is sold by Shazam Entertainment, Ltd. Another example would be a similar process performed on a video broadcast media data stream, identifying the video broadcast as, for example, a movie, music video, or television show.

When analysis of a broadcast media data stream is used to identify a good or service desired for purchase, several methods and means may be used to obtain such identification. Receiver 14, either automatically for all or certain types of data streams, or upon receiving an indication of a desire for purchase, may analyze the broadcast media data stream and determine the identification data for the stream. Alternatively, receiver 14 may request an analysis of the broadcast media data stream from an remote device, such as server 32 or second computer 34. The remote device may then respond to the request with the identification data. Once identification data is obtained, receiver 14 may then proceed to create the necessary purchase data and request a purchase of the desired good or service.

In yet another alternative, receiver 14 may request a purchase of a good or service and provide a portion of the broadcast media data stream to a remote device, such as server 32 or second computer 34. For example, receiver 14 may provide portion of the broadcast media data stream, such as sample of a song or a video, to the remote device, which the remote device then analyzes to determine identification data associated with the broadcast media data stream. The remote device may then obtain or determine the purchase information, create the purchase data, and complete the purchase. In another alternative, receiver 14 may request a purchase of a good or service and provide sufficient information to a remote device so that the remote device can locate the broadcast media data stream associated with the good or service. For example, receiver 14 may provide a time, date, and broadcasting station with a purchase request, which the remote device may use to obtain a copy of the broadcast media data stream or otherwise locate the associated good or service. The remote device may then obtain or determine the purchase information, create the purchase data, and complete the purchase.

The purchase data may include the identification of the purchaser, such as a code, token, MIN, Pin number, or other indicia, and data sufficient to identify the good or service desired purchase. If the purchase data is not immediately transmitted from the broadcast receiver 14 when created, it can be stored in the memory 40 and transmitted through the communication interface 42 at a predetermined location or time. The broadcast receiver 14 can include any wired or wireless means of communication for the communication interface 42 as known in the art, such as radio frequency (RF) and infrared (IR) communications, to communicate with the server 32, home computer 16, receiver 22, or satellite 24, or any other computer device.

While the broadcast receiver 14 is shown here as a single device on a platform 38, the broadcast receiver 14 may be comprised of several devices, each of which may perform one or more functions as stated herein. In one embodiment, a separate device for purchase selector 48 and communication interface 42 that communicates with a separate broadcast receiver 46, either by a wired or wireless connection, may extract any information data that is in the broadcast media otherwise being received by the broadcast receiver 14 such that the person can purchase the good or service being advertised. For example, if broadcast receiver 46 is a home stereo, separate purchase selector 48 and communication interface 42 could be placed either in proximity to the home stereo or connected thereto and when a listener hears a good or service advertised in the radio broadcast, he or she may activate purchase selector 48 to purchase the good or service in the manner described herein.

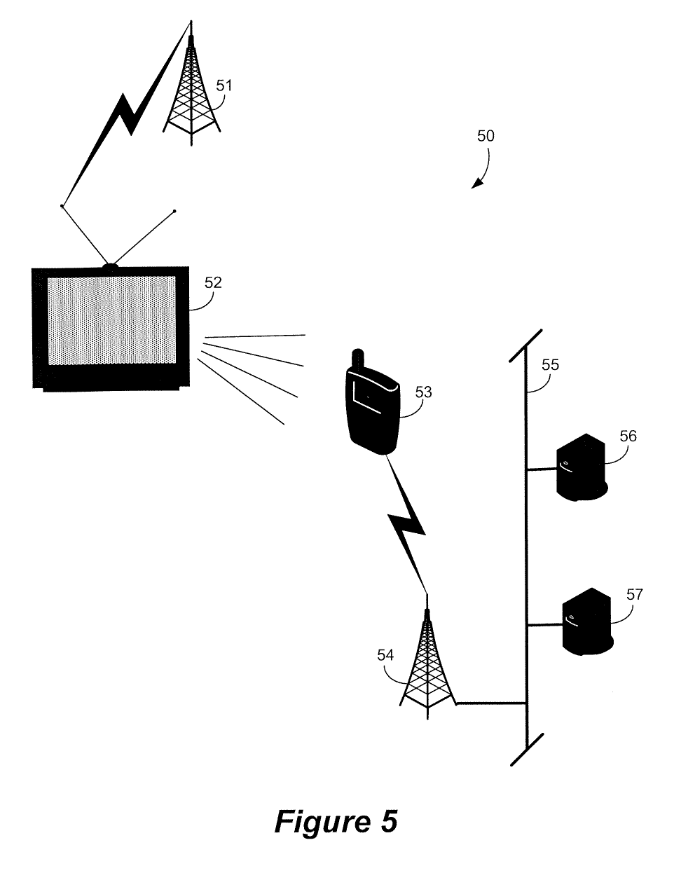

In another embodiment, purchase selector 48 and communication interface 42 may be implemented in a separate device, such as a mobile telephone, and used to purchase goods based on identification data derived from analyzing broadcast media data streams from traditional broadcast receiver devices, such as radios and televisions. Referring now to FIG. 5, illustrating system 50, a broadcast receiving device is illustrated as television 52, that may be receiving a broadcast media data stream from broadcast network 51. Television 52 may also be a radio, video monitor, stereo, or any other music, video, or media reproduction device. A user may be operating device 53, which may detect the broadcast media data stream by capturing audio using a microphone or video by using a camera. Device 53 may be a telephone (mobile or fixed line), personal data assistant (“PDA”), computer, or any other device capable of detecting a broadcast media data stream and communicating with other devices. Other components may be installed on device 53 which may be used to detect various types of broadcast media data streams, such as the “Shazam” music recognition software, and other means and mechanisms of capturing portions of a broadcast media data stream are known to those skilled in the art can alternately be used. The various components described with regard to broadcast receiver 14 may in FIG. 2 may also be variously contained and/or configured within device 53.

The broadcast media data stream captured may be any media stream which is detectable by device 53. For example, a radio broadcast or television broadcast may be detected. Likewise, a satellite or cable radio or television stream may be detected. Alternatively, recordings of media streams may be detected, such as video or audio content contained on any of various media types, including, but not limited to, compact disks, DVDs, video or audio cassettes, analogue formats such as vinyl records, digital copies such as MP3s or any other digital media storage means. Any form of media or media stream that may be detected by an appropriately equipped device is contemplated as within the scope of the present disclosure.

If a user of device 53 desires to purchase a good or service associated with the broadcast media data stream received on television 52, the user may select a purchase selector, such as purchase selector 48, on device 53. Device 53 may then capture at least a portion of the broadcast media data stream, or the entire broadcast media data stream. Alternatively, the user may operate device 53 to capture a portion of or the entire broadcast media data stream first, and then select a purchase selector on device 53.

Once a purchase request is made and at least a portion of the broadcast media data stream is captured by device 53, device 53 may analyze the broadcast media data stream to determine identification data associated with the broadcast media data stream. This may be performed on device 53 itself, using mechanisms known to those skilled in the art. Alternatively, device may communicate with network 55 via wireless communication tower 54, and transmit at least a portion of the broadcast media data stream to a remote device, such as server 56 or server 57, for analysis. In yet another alternative, instead of communicating portions of a broadcast media data stream, device 53 may communicate other relevant data that would allow a remote device to determine the identity of the broadcast media data stream. Examples of such data include time, date, and broadcast station identification information. Any other information that may be obtained by a device and used to determine the identity of a broadcast media data stream is contemplated as within the scope of the present disclosure. Communication between device 53 and a remote device may be by any means known to those skilled in the art, including Wi-Fi, CDMA, GSM, or any other wireless or wired communication technology.

The remote device may the analyze the broadcast media data stream portion, or other related information provided by device 53, and determine the identification data associated with the broadcast media data stream. This may be accomplished using any of the means and mechanisms known to those skilled in the art. Once determined, the identification data may be transmitted to device 53. Device 53 may then use the identification data to create purchase data and transmit a purchase request. Alternatively, the purchase data may be created on another device, such as server 56 or server 57, using the identification data. In such an embodiment, device 53 may, upon receiving an indication from a user that a purchase is desired, transmit a purchase request to a remote device with a portion of a broadcast media data stream or other relevant data. Device 53 may then receive a confirmation of the purchase or notification that the purchase failed.

One advantage of the present systems 10 and 50 is that the broadcast media data stream does not have to overtly and explicitly include information about the purchase of the goods and services. The broadcast media data stream may not include information about the purchase of the goods and services at all. As an example, if the broadcast media is a radio broadcast, each song does not have to include an advertisement of its identity or even state that it is available for purchase to the user of the broadcast receiver 14 or device 53. As long as the broadcast media includes identification data such that the broadcast receiver can identify the good or service desired to be purchased, or the broadcast media data stream can be analyzed to determine identification data, the person can simply indicate a desire to purchase, such as pressing button 15 or a similar button on device 53, and the broadcast receiver 14 or device 53 will attempt to complete a purchase of the good or service. Broadcast receiver 14 or device 53 may also inform the person if the good or service has been successfully purchased, or if the good or service is not purchasable using system 10 or 50. Thus, the broadcast media is not required to include any explicit information in the broadcast media stream about the purchase of the goods and services. It should also be noted that the good or service can be a tangible good or service, such as purchase of an album or ticket to a concert, or can be another payment or secure transaction, such as a donation to a cause or a political contribution.

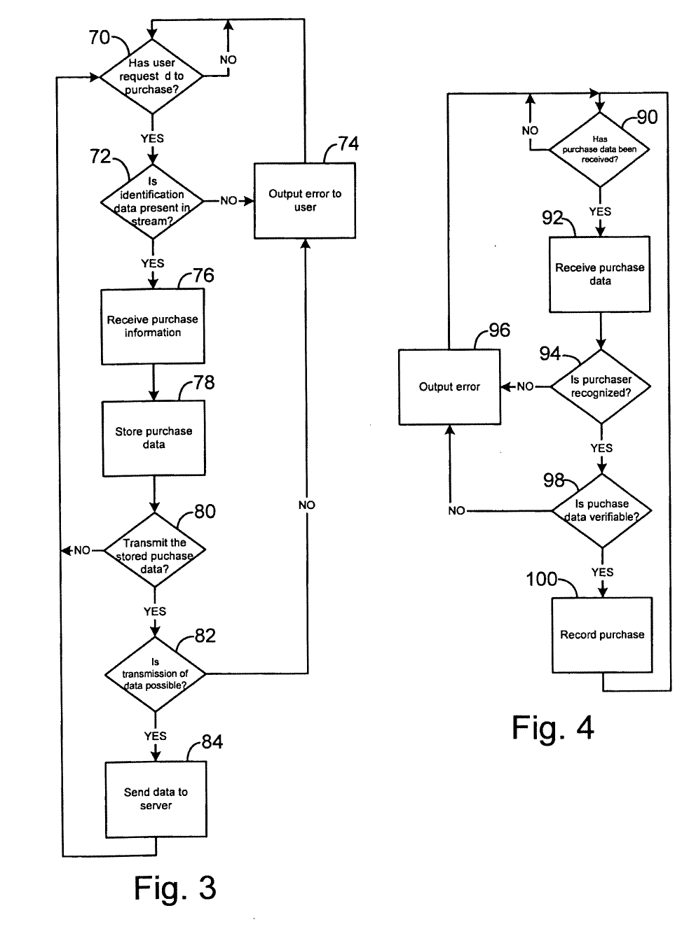

FIG. 3 is a flowchart of the process executing on broadcast receiver 14 to purchase goods or services linked with the received broadcast media. This embodiment illustrates the process used when broadcast media data stream analysis to determine identification data is not available. Broadcast receiver 14 makes a determination as to whether the user has requested to purchase a good or service, as shown at block 70. If no purchase has been indicated at block 70, then the process reiterates such that the broadcast receiver 14 is in a wait state for user input. Otherwise, if the user requests to purchase at block 70 (i.e. pressed button 15), a determination is then made as to whether identification data is present in the broadcast data stream such that the good or service desired to be purchased can be identified, as shown at block 72. If there is no identification data present at block 72, then an error is output to the user, as shown at block 74, and then process returns to block 70.

Otherwise, if the identification data is present in the broadcast media stream at block 72, the purchase information is received, as shown at block 76, and the purchase data is then generated and stored at block 78. While this embodiment stores the data in memory 40, block 78 is not necessary if immediate transmission of the purchase data is effected. A determination is then made as to whether the purchase data should be transmitted, as shown at block 80, which can be a decision as to whether a period has elapsed or transmission of the purchase data at that time is otherwise desirable. If the transmission of the purchase data is not indicated at block 80, then the process returns to block 70 to await further user input. Otherwise, if transmission of the purchase data is indicated at block 80, then a determination is made as to whether the transmission of the purchase data is possible at that moment, as shown at block 82. If the transmission of the purchase data is not possible at block 82, then an error is outputted to the user at block 74 and the process returns to block 70 to await user input. Or, if the transmission of the purchase data is possible at block 82, then the purchase data is sent to the server 32, as shown at block 84, and then the process returns to block 70 to await user input.

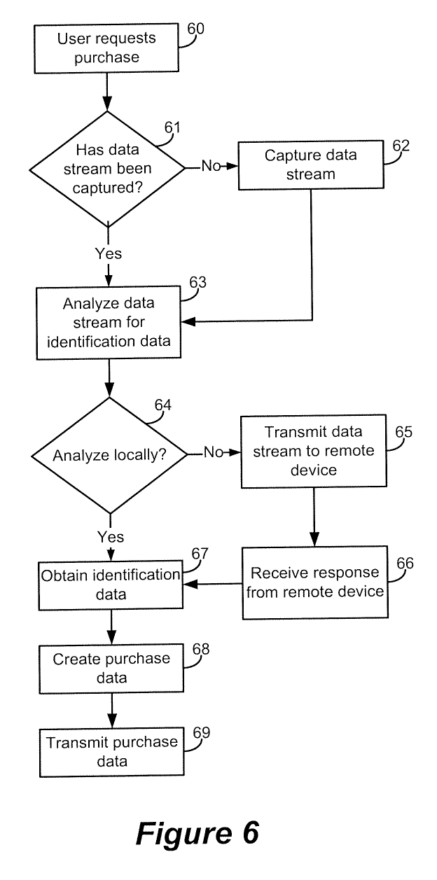

FIG. 6 is a flowchart of the process executing on device 53 to purchase goods or services associated with a detected broadcast media data stream. This embodiment illustrates the process used when a broadcast media data stream is analyzed to determine identification data. At block 60 the user requests the purchase of a good or service associated with a broadcast media data stream. This request may be detected through the selection of a button, such as button 15, or the selection of a purchase request through a menu, voice prompt, mouse click, or any other means of indicating a desire to purchase a good or service associated with a broadcast media data stream. At block 61, a determination is made as to whether a sufficient portion of the broadcast media data stream has been captured to complete the purchase request. The amount of the broadcast media data stream required to complete analysis and obtain identification data, and therefore complete a purchase request, may vary by implementation. A sample of a song or short clip from video content, for example, may suffice. Other forms of media may require varying amounts and qualities of broadcast media data stream capture.

In one embodiment, the user makes a purchase request before capturing on device 53 a sufficient portion of the broadcast media data stream. In this case, at block 62, a portion of the broadcast media data stream is captured. In another embodiment, the broadcast media data stream is captured before the user make a purchase request. This may occur when the user knows that a purchase request is likely, and the user manually captures a portion of the broadcast media data stream before making the purchase request. Alternatively, device 53 may be configured to be continually capturing any broadcast media data stream that is can detect, or it may be configured to automatically selectively capture broadcast media data streams.

After at least a portion of the broadcast media data stream is captured, it is analyzed at block 63 for identification data. At block 64, it is determined whether such analysis is to be performed locally, for example on device 53, or remotely, for example on server 56 or 57. If it is to be dome remotely, then, at block 65, the broadcast media data stream portion is transmitted to a remote device for analysis. This may be transmission over a wireless or wireline network. The remote device performing the analysis may be a single device or several devices working in conjunction with one another. The forms of analysis that may be performed are known to those skilled in the art, and include, but are not limited to, determining a song title and artist from a sample of a song and determining a title and producer of video content from a video clip. At block 66, device 53 receives a response to the request for analysis from the remote device. At block 67, device 53 obtains identification information associated with the broadcast media data stream, either from its own analysis or from the response received from a remote device performing analysis.

At block 68, device 53 creates the purchase data required to complete the purchase. This may include creating a purchase request including the identification data obtained at block 67, as well as information about the purchaser. Purchaser information may include name, address, credit card data, and any other information that may assist in completing a purchase. At block 69, the purchase data is transmitted to a purchasing server which receives purchase data and completes the purchase.

It should be appreciated that the processes illustrated in FIGS. 3 and 6 may have elements which can be combined, interchanged, or removed, and still remain within the scope of the present disclosure.

FIG. 4 is a flowchart illustrating one embodiment of the process executing on a remote device, such as server 32 or server 56, that receives purchase data from broadcast receiver 14 or device 53. This embodiment of a purchasing server awaits the receipt of purchase data, and thus a determination is first made as to whether purchase data has been received from broadcast receiver 14 or device 53, as shown at block 90. The purchasing server can alternately be embodied so as to poll or request devices such as broadcast receiver 14 and device 53 send any stored purchase data. If no purchase data has been received at block 90, then the process iterates at block 90 to await purchase data. Otherwise, if purchase data has been received at block 90, then purchase data is received as shown at block 92, and then a determination is made as to whether the purchaser is recognized as shown at block 94.

The recognition of the purchaser can be from a specific database of purchasers, such as those signed up for the service, or those otherwise identifiable to the server 32 based upon the purchase data. As an example, a purchaser signs up at a website and pre-purchases songs, and the purchasing server will recognize the purchaser and credit the song accordingly. Another example is a credit card number being located in the purchase data sent from broadcast receiver 14 or device 53. In this embodiment, the user of broadcast receiver 14 or device 53 inputs his or her credit card data at a convenient time and the device stores the credit card data and transmits it with the purchase data sent when a purchase selection indicator, such as button 15, is actuated. The purchasing server can then identify the purchaser upon receipt of the credit card data.

If the purchaser is not recognized at block 94, then an error is output, either to an operator of the purchasing server or a general error can be thrown in the Server OS, as shown at block 96 and the process returns to block 90 to await the receipt of purchase data. Otherwise, if the purchaser can be recognized at block 94, then a decision is made as to whether the purchase data is verifiable as shown at block 98. If the purchase data is not verifiable at block 98, then an error is output at block 96 and the process returns to block 90 to await purchase data receipt. Otherwise, if the purchase data is verifiable at block 98, in conjunction with the purchaser being recognized at block 94 (a precondition), the purchase is recorded at block 100, and the process returns to block 90 to await further purchase data.

It should be appreciated that blocks 94 and 98 can be combined, and other determinations can be made before the purchase data is accepted. Moreover, the link between the broadcast receiver 14 to the server 32 from step 84 to step 92 can be a SSL or other type of secure link so that the purchase data is secure.

It should further be appreciated that the processes illustrated in FIGS. 3, 4 and 6 may have elements which can be combined, interchanged, or removed, and still remain within the scope of the present disclosure. For example, in one embodiment where the broadcast media data stream is analyzed by a remote device for identification data, the analyzing device or devices may also receive from a requesting device, such as broadcast receiver 14 or device 53, other purchase information which then allows the analyzing device or devices to proceed with completing the purchase as soon as the broadcast media data stream is identified. This may assist in creating a quick and simple way to purchase a good or service associated with a broadcast media data stream, even when explicit identification data is not embedded or otherwise included within the stream.

It can thus be seen that the systems 10 and 50 provide an inventive method for purchasing goods and services linked or associated with media, such as radio and television broadcasts and cable and satellite transmissions, including the steps of receiving at a broadcast receiver 14 or detecting on a device 53 a broadcast media data stream which may include information relating to goods and services that can be purchased by persons receiving the broadcast media data stream, analyzing, if needed, the broadcast media data stream to determine identification data, selectively recording purchase data at the broadcast receiver 14 or device 53 for a good and service that a person purchases relating to the broadcast media or selectively recording purchase data at a server such as servers 32, 34, 56, and 57, sending the purchase data, if necessary, from the broadcast receiver 14 or device 53 to at least one server, such as server 32, 56 or 57; receiving the purchase data at the at least one server 32, 56 or 57, and verifying the purchase data sent from the broadcast receiver 14 or device 53 at the least one server 32, 56 or 57. The step of sending the purchase data can be sending the purchase data to a plurality of servers, such as servers 32, 34, 56, and 57, and then the method can further include the step of storing the purchase data at one of the servers, such as server 32 or 56, and then the step of verifying the purchase data occurs at a different server, such as server 34 or 57.

The step of sending the purchase data can be sending the purchase data from the broadcast receiver 14 or device 53 to the server 32, 34, 56, or 57 via a secure communication channel, such as through a SSL or other data encryption method. The method can further include the steps of storing the purchase data at the broadcast receiver 14 or device 53, such as in memory 40, and then transmitting the stored purchase data from the broadcast receiver 14 or device 53 to the server 32, 34, 56, or 57 when the broadcast receiver 14 or device 53 is at a predetermined location, such as at home 24 or near the receiver 22 or communication tower 54. The method may also include the steps of storing the purchase data at the broadcast receiver 14 or device 53, and transmitting the stored data from the broadcast receiver 14 or device 53 to the server 32, 34, 56, or 57 at a predetermined period of time.

Further, the step of receiving at broadcast receiver 14 or television 52 a broadcast media data stream may be receiving a radio signal at a radio receiver, such as shown with broadcast receiver 14 of FIG. 2 or a television signal, such as shown with television 52 in FIG. 5. The receiving at broadcast receiver 14 or television 52 of a broadcast media data stream may be the receiving of a broadcast media data stream that either includes or does not include information about the purchase of goods and services contained within the broadcast media data stream. If information about the purchase of goods or services is not contained within the broadcast media data stream, broadcast receiver 14 or a related device such as device 53 may or may not analyze, or request analysis of, the broadcast media data stream to determine identification information needed to complete the purchase of a good or service.

In the context of FIGS. 3, 4 and 6, the present method may be implemented, for example, by operating portion(s) of the broadcast receiver 14 or device 53, such as main processor 44, and server 32, to execute a sequence of machine-readable instructions. The instructions can reside in various types of signal-bearing or data storage primary, secondary, or tertiary media. The media may comprise, for example, RAM (not shown) accessible by, or residing within, the components of networks 18 or 55, or LAN 30. Whether contained in RAM, a diskette, or other secondary storage media, the instructions may be stored on a variety of machine-readable data storage media, such as DASD storage (e.g., a conventional “hard drive” or a RAID array), magnetic tape, electronic read-only memory (e.g., ROM, EPROM, or EEPROM), flash memory cards, an optical storage device (e.g. CO-ROM, WORM, DVD, digital optical tape), paper “punch” cards, or other suitable data storage media including digital and analog transmission media. Furthermore, any functions stated herein can be implemented in hardware, software, or firmware with digital logic and/or software code as would be apparent to one of skill in the art.

While the foregoing disclosure shows illustrative embodiments of the invention, it should be noted that various changes and modifications could be made herein without departing from the scope of the invention as defined by the appended claims. Furthermore, although elements of the invention may be described or claimed in the singular, the plural is contemplated unless limitation to the singular is explicitly stated.

What is claimed is:

1. A system for purchasing goods and services associated with a media stream, the system comprising:
a selector which may be selected by a purchaser, the selector indicating that the purchaser desires to purchase a good or service associated with a media stream;
a detector that detects at least a portion of the media stream;
a transmitter that transmits at least a portion of the media stream to an analyzing device;
a receiver that receives from the analyzing device identification data associated with the media stream, wherein the analyzing device analyzes the transmitted media stream to determine the identification data;
a processor that creates purchase data, the purchase data comprising the identification data, wherein the processor instructs the transmitter to transmit the purchase data to a purchasing device.

2. The system of claim 1, wherein the purchase data further comprises purchaser identification data.

3. The system of claim 2, further comprising a memory that stores the purchase data.

4. The system of claim 1, further comprising a media stream receiver that receives the media stream from a media source.

5. The system of claim 1, further comprising a memory that stores the purchase data for transmission by the transmitter at a predetermined location.

6. A method for purchasing goods and service associated with a media stream, the method comprising:
receiving a portion of a media stream from a purchasing device;
analyzing the portion of the media stream to determine identification data associated with the media stream;
transmitting the identification data to the purchasing device;
receiving purchase data from the purchasing device, the purchase data comprising the identification data and purchaser identification data;
completing a purchase of a good or service associated with the media stream.

7. The method of claim 6, further comprising transmitting a confirmation of a completed purchase of the good or service to the purchasing device.

8. The method of claim 6, wherein the portion of the media stream is one of an audio sample and a video clip.

9. The method of claim 6, wherein the purchasing device is a mobile telephone.

10. The method of claim 6, wherein completing a purchase of a good or service associated with the media stream further comprises transmitting purchase data to a merchant device.

11. A method for purchasing goods and service associated with a media stream, the method comprising:
receiving a portion of a media stream and purchase data from a purchasing device;
analyzing the portion of the media stream to determine identification data associated with the media stream;
determining, based on the identification data, a good or service associated with the media stream;
completing a purchase of the good or service associated with the media stream using the purchase data.

12. The method of claim 11, further comprising transmitting a confirmation of a completed purchase of the good or service to the purchasing device.

13. The method of claim 11, wherein completing a purchase of a good or service associated with the media stream further comprises transmitting purchase data to a merchant device.

14. The method of claim 13, wherein the purchase data is transmitted to a merchant device over a secure connection.

15. The method of claim 13, wherein completing a purchase of a good or service associated with the media stream further comprises receiving verification of the purchase data from the merchant device.

16. A broadcast receiver for purchasing goods and services associated with broadcast media, the broadcast receiver receiving a broadcast media stream, the broadcast receiver further analyzing the broadcast media stream to determine identification data for a good or service associated with the broadcast media stream, the broadcast receiver further selectively recording purchase data for the good or service associated with the broadcast media stream, the purchase data comprising at least the identification data, and the broadcast receiver further selectively transmitting the purchase data to another computer device.

17. The broadcast receiver of claim 16, further comprising a purchase selection indicator.

18. The broadcast receiver of claim 16, wherein the broadcast receiver further stores the purchase data and transmits the stored data at a predetermined location.

19. The broadcast receiver of claim 16, wherein the purchase data further comprises purchaser identification data which is stored in a memory on the broadcast receiver.

20. The broadcast receiver of claim 16 further receiving a confirmation of a purchase completion.

21. The broadcast receiver of claim 16, wherein the broadcast receiver further analyzing the broadcast media stream to determine identification data for a good or service associated with the broadcast media stream comprises transmitting broadcast media stream data to an analyzing device and receiving identification data from the analyzing device.

22. The broadcast receiver of claim 21, wherein the broadcast media stream data comprises a portion of the broadcast media stream.

23. The broadcast receiver of claim 21, wherein the broadcast media stream data comprises a time and source of the broadcast media stream.
